(19) United States
(12) Patent Application Publication
(10) Pub. No.: US 2012/0154808 A1
(43) Pub. Date: Jun. 21, 2012

(54) METHOD FOR DETECTING THE OPTIMUM VIEWING DISTANCE OF THREE-DIMENSIONAL DISPLAY

(75) Inventors: Hsiu-Hung Lin, Taipei County (TW); Che-Wei Chang, Taoyuan County (TW)

(73) Assignee: Chunghwa Picture Tubes, LTD., Taoyuan (TW)

(21) Appl. No.: 13/031,250

(22) Filed: Feb. 21, 2011

(30) Foreign Application Priority Data
Dec. 21, 2010 (TW) 99144961

(51) Int. Cl. G01B 11/00

(52) U.S. Cl. 356/400

(57) ABSTRACT

A method for detecting the optimum viewing distance of three-dimensional display is provided, which includes: providing a three-dimensional display having a display screen to display at least a testing pattern thereon; providing a platform with an included angle towards the display screen at a side of the three-dimensional display, wherein the testing pattern on the display screen is suitable to be projected onto the platform; providing an image sensing element over the platform to capture the testing pattern projected on the platform for producing an image frame. The image frame includes at least a first color area and at least a second color area. The first color area partially overlaps the second color area. The non-overlapping areas of the first color area and the second color area are defined as an optimum viewing distance.

### CROSS-REFERENCE TO RELATED APPLICATION

This application claims the priority benefit of Taiwan application serial no. 99144961, filed on Dec. 21, 2010. The entirety of the above-mentioned patent application is hereby incorporated by reference herein and made a part of this specification.

### BACKGROUND OF THE INVENTION

1. Field of the Invention

The invention generally relates to a detection method, and more particularly, to a method for detecting the optimum viewing distance of three-dimensional display.

2. Description of Related Art

Along with the progress and development of science and technology, the people's enjoyments on material and spirituous livings are steadily increasing and never declining. In term of spirituous living, in the age of science and technology dazzlingly changed, people wish by means of a three-dimensional display to make fantastic imaginations come true, so as to have the effect being personally on the scene. In this regard, how to make a three-dimensional display present three-dimensional pictures or images has become an object to be desiderating achieved in the three-dimensional display technology field today.

The three-dimensional displaying technology is roughly divided into the stereoscopic three-dimensional displaying technology where a user needs to wear a pair of specifically designed eye glasses and the auto-stereoscopic three-dimensional displaying technology where a user uses naked eyes to directly watch. The stereoscopic three-dimensional displaying technology today has become mature by developments and is broadly applied in some specific applications such as military simulation or grand entertainment. However, due to poor convenience and comfort, the stereoscopic three-dimensional displaying technology is uneasy to be popular. Therefore, the auto-stereoscopic three-dimensional displaying technology has been evolved gradually and become a new tendency.

The auto-stereoscopic three-dimensional displaying technology is mainly based on the work principle that a fixed-type optical grating is used to control the images received by the left eye and the right eye of a viewer. When the left eye and the right eye respectively watch two images with the same image content but having different parallaxes, according to the visualization characteristic of human naked eyes, the human eyes would observe the two images and see a three-dimensional image by means of overlapping the two images with each other and interpreting the overlapped images. In comparison with the stereoscopic three-dimensional display, although the auto-stereoscopic three-dimensional display is advantageous in no need to wear a pair of glasses to see three-dimensional images, but the auto-stereoscopic three-dimensional display has a limitation of the optimum viewing distance.

In the conventional method for detecting the optimum viewing distance of auto-stereoscopic three-dimensional display, a detector placed at different positions or from different angles detects testing patterns on a display screen. In terms of detecting four testing patterns on the display screen of a three-dimensional display, it is required to detect the light intensity distributions given by at least four different testing patterns, wherein the light intensity distributions respectively represent the optical characteristics of the four testing patterns at different positions. Taking an example that the detection scope is between +45° and −45° with a detection unit of 0.5° and the time for detecting per point is about 10 seconds, then, the total detection time would be 181 (points)×10 (seconds)×4 (times)=120 minutes. When the larger the detection scope or the more the testing patterns, the relatively longer the detection time spends.

### SUMMARY OF THE INVENTION

Accordingly, the invention is directed to a method for detecting the optimum viewing distance of three-dimensional display by which the optimum viewing distance for any auto-stereoscopic three-dimensional display can be quickly obtained.

The present invention provides a method for detecting the optimum viewing distance of three-dimensional display, which includes following steps. A three-dimensional display is provided, wherein the three-dimensional display has a display screen to display at least a testing pattern thereon. A platform at a side of the three-dimensional display is provided, wherein an included angle is formed between the display screen and the platform, and the testing pattern on the display screen is suitable to be projected onto the platform. An image sensing element over the platform is provided to capture the testing pattern projected on the platform for producing an image frame, wherein the image frame includes at least a first color area and at least a second color area, the first color area partially overlaps the second color area, and the non-overlapping areas of the first color area and the second color area are defined as an optimum viewing distance.

In an embodiment of the present invention, the above-mentioned included angle ranges between 0° and 89°.

In an embodiment of the present invention, the above-mentioned image sensing element is a charge coupled device. (CCD).

In an embodiment of the present invention, the above-mentioned three-dimensional display is an auto-stereoscopic three-dimensional display.

In an embodiment of the present invention, the distance between the above-mentioned image sensing element and the platform is between 2 meters and 200 meters.

In an embodiment of the present invention, the above-mentioned non-overlapping areas of the at least a first color area and the at least a second color area are distributed alternately.

In an embodiment of the present invention, the above-mentioned optimum viewing distance is substantially a distance range between the eyes of a user and the display screen of the three-dimensional display.

In an embodiment of the present invention, the above-mentioned partially overlapping area of the first color area and the second color area is located between the display screen and the non-overlapping areas of the first color area and the second color area.

In an embodiment of the present invention, the above-mentioned testing pattern includes long-bar shape pattern or rectangular pattern.

In an embodiment of the present invention, the area of the above-mentioned testing pattern is less than the area of the display screen.

Based on the depiction above, the method for detecting the optimum viewing distance of three-dimensional display in the invention adopts an image sensing element to capture the testing pattern projected on the platform of the three-dimensional display. Hence, in comparison with the prior art where the optimum viewing distance of the three-dimensional display is detected by using a detector with different positions or different angles, the detection method of the invention can quickly obtain the optimum viewing distance of any auto-stereoscopic three-dimensional display.

In order to make the aforementioned and other features and advantages of the invention comprehensible, several exemplary embodiments accompanied with figures are described in detail below.

### BRIEF DESCRIPTION OF THE DRAWINGS

FIG. 1 is a schematic flow chart of a method for detecting the optimum viewing distance of three-dimensional display according to an embodiment of the invention.

FIG. 2A is a diagram showing the positions of a three-dimensional display, a platform and an image sensing element of the invention.

FIG. 2B is a diagram of the display screen and a testing pattern of the three-dimensional display of the invention.

FIG. 2C is a diagram of the display screen and another testing pattern of the three-dimensional display of the invention.

FIG. 3A is a diagram showing an image frame captured by an image sensing element in the invention, wherein the image frame is produced by the testing pattern projected on the platform.

FIG. 3B is a diagram showing another image frame captured by an image sensing element in the invention, wherein the image frame is produced by the testing pattern projected on the platform.

### DESCRIPTION OF THE EMBODIMENTS

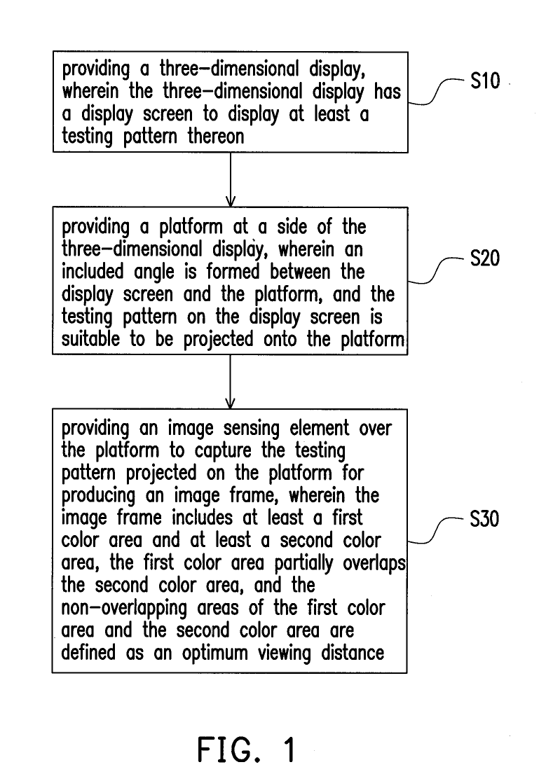

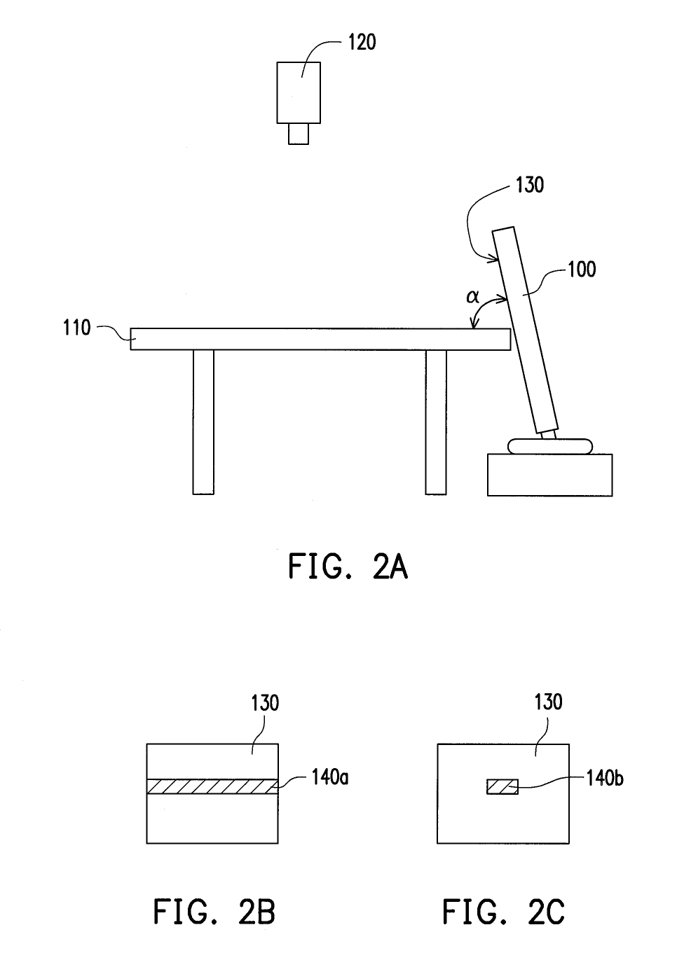

FIG. 1 is a schematic flow chart of a method for detecting the optimum viewing distance of three-dimensional display according to an embodiment of the invention. FIG. 2A is a diagram showing the positions of a three-dimensional display, a platform and an image sensing element of the invention. FIG. 2B is a diagram of the display screen and a testing pattern of the three-dimensional display of the invention. It should be noted that wherever possible, the same reference numbers are used in the drawings and the description to refer to the same or like parts and the same technical content depictions are omitted.

Referring to FIGS. 1, 2A and 2B, the method for detecting the optimum viewing distance of three-dimensional display in the embodiment includes following steps. First in step S10, a three-dimensional display 100 is provided, wherein the three-dimensional display 100 has a display screen 130 and the display screen 130 displays at least a testing pattern 140a thereon. In the embodiment, the three-dimensional display 100 is an auto-stereoscopic three-dimensional display. It should be noted that the embodiment does not limit the screen size, the aspect ratio or the diagonal length of the three-dimensional display 100. As long as the three-dimensional display is substantially an auto-stereoscopic three-dimensional display, the detection method of the embodiment can be adopted.

As shown in FIG. 2B of the embodiment, the area of the testing pattern 140a is substantially less than the area of the display screen 130 and the testing pattern 140a can be a long-bar shape pattern as an embodiment, but in other embodiments, the testing pattern 140b can be a rectangular pattern as well, referring to FIG. 2C. In other unshown embodiments, the testing pattern can be other appropriate patterns. In short, the testing patterns in FIGS. 2B and 2C are examples for explanation purpose only, which the invention is not limited to.

Next in step S20, referring to FIGS. 1 and 2A, a platform 110 at a side of the three-dimensional display 100 is provided, wherein an included angle α is formed between the display screen 130 and the platform 110, and the testing pattern 140a (or the testing pattern 140b) on the display screen 130 is suitable to be projected onto the platform 110. In the embodiment, the range of the included angle a ranges, for example, between 0° and 89°.

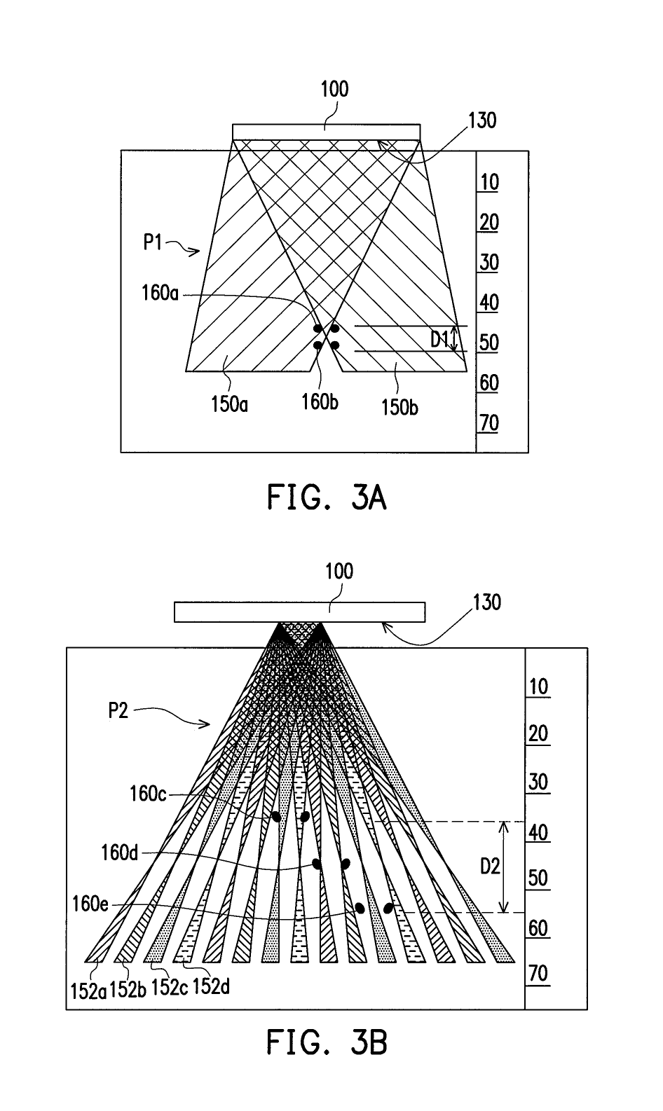

Finally in step S30, referring to FIGS. 1, 2A and 3A, herein, FIG. 3A is a diagram showing an image frame captured by an image sensing element in the invention, wherein the image frame is produced by the testing pattern projected on the platform. An image sensing element 120 over the platform 110 is provided to capture the testing pattern 140a projected on the platform 110 (referring to FIG. 2B or the testing pattern 140b of FIG. 2C) so as to produce an image frame P1. The image sensing element 120 herein is a CCD, and the distance between the image sensing element 120 and the platform 110 is between 2 meters and 200 meters.

In particular, in the embodiment, the image frame P1 includes a first color area 150a and a second color area 150b, wherein the first color area 150a partially overlaps the second color area 150b, and the non-overlapping areas of the first color area 150a and the second color area 150b are defined as an optimum viewing distance D1. In more details, the partially overlapping area of the first color area 150a and the second color area 150b is located between the display screen 100 and the non-overlapping areas of the first color area 150a and the second color area 150b. The optimum viewing distance D1 is substantially a distance range between the eyes 160a (or 160b) of a user and the display screen 130 of the three-dimensional display 100. Therefore, the user can make length marks on the platform 110 in advance (referring to marks 10, 20 30, etc. in FIG. 3A), by which the optimum viewing distance D1 of the image frame P1 captured by the image sensing element 120 can be obtained (for example, 43 centimeters to 50 centimeters). After that, the real distance range between the eyes 160a (or 160b) of a user and the display screen 130 of the three-dimensional display 100 can be obtained by conversion calculating of a scale. At the time, the optimum viewing distance D1 of the three-dimensional display 100 is obtained.

It should be noted that the invention does not limit the type of the image frame P1. Although the mentioned image frame P1 here, as an embodiment, includes the first color area 150a and the second color area 150b only, however, the above-mentioned testing pattern consists of patterns pictured from different angles of view (AOVs). When the more the patterns of different AOVs, the more the color areas are. As a result, the more the testing patterns, the more the light intensity distributions presented by the detected testing patterns are. In other embodiments, referring to FIG. 3B, an image frame P2 can include a plurality of first color areas 152a, a plurality of second color areas 152b, a plurality of third color areas 152c and a plurality of fourth color areas 152d, wherein the first color areas 152a, the second color areas 152b, the third color areas 152c and the fourth color areas 152d partially overlap each other, while the non-overlapping areas of the first color areas 152a, the second color areas 152b, the third color areas 152c and the fourth color areas 152d are distributed alternately and the non-overlapping area are defined as an optimum viewing distance D2 of the three-dimensional display 100.

In short, the method for detecting the optimum viewing distance of three-dimensional display of the embodiment adopts an image sensing element 120 to capture the testing pattern 140a (or 140b) projected on the platform 110 of the auto-stereoscopic three-dimensional display 100. Hence, in comparison with the prior art where the optimum viewing distance of a three-dimensional display is detected by using a detector with different positions or different angles, the detection method of the embodiment can quickly obtain the optimum viewing distance D1 (or D2) of an auto-stereoscopic three-dimensional display 100. In addition, the detection method is also capable of detecting various auto-stereoscopic three-dimensional displays and does not limit the screen size, the aspect ratio or the diagonal length of an auto-stereoscopic three-dimensional display, which can advance the convenience of detecting the optimum viewing distance D1 (or D2) of various three-dimensional displays 100.

In summary, since the method for detecting the optimum viewing distance of three-dimensional display in the invention adopts an image sensing element to capture the testing pattern projected on the platform of the three-dimensional display, so that in comparison with the prior art where the optimum viewing distance of the three-dimensional display is detected by using a detector with different positions or different angles, the detection method of the invention can quickly obtain the optimum viewing distance of any auto-stereoscopic three-dimensional display.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A method for detecting the optimum viewing distance of three-dimensional display, comprising:
providing a three-dimensional display, wherein the three-dimensional display has a display screen to display at least a testing pattern thereon;
providing a platform at a side of the three-dimensional display, wherein an included angle is formed between the display screen and the platform, and the testing pattern on the display screen is suitable to be projected onto the platform; and
providing an image sensing element over the platform to capture the testing pattern projected on the platform for producing an image frame, wherein the image frame comprises at least a first color area and at least a second color area, the first color area partially overlaps the second color area, and the non-overlapping areas of the first color area and the second color area are defined as an optimum viewing distance.

2. The method for detecting the optimum viewing distance of three-dimensional display as claimed in claim 1, wherein the included angle ranges between 0° and 89°.

3. The method for detecting the optimum viewing distance of three-dimensional display as claimed in claim 1, wherein the image sensing element is a charge coupled device.

4. The method for detecting the optimum viewing distance of three-dimensional display as claimed in claim 1, wherein the three-dimensional display is an auto-stereoscopic three-dimensional display.

5. The method for detecting the optimum viewing distance of three-dimensional display as claimed in claim 1, wherein the distance between the image sensing element and the platform is between 2 meters and 200 meters.

6. The method for detecting the optimum viewing distance of three-dimensional display as claimed in claim 1, wherein the non-overlapping areas of the at least a first color area and the at least a second color area are distributed alternately.

7. The method for detecting the optimum viewing distance of three-dimensional display as claimed in claim 1, wherein the optimum viewing distance is substantially a distance range between the eyes of a user and the display screen of the three-dimensional display.

8. The method for detecting the optimum viewing distance of three-dimensional display as claimed in claim 1, wherein the partially overlapping area of the first color area and the second color area is located between the display screen and the non-overlapping areas of the first color area and the second color area.

9. The method for detecting the optimum viewing distance of three-dimensional display as claimed in claim 1, wherein the testing pattern comprises long-bar shape pattern or rectangular pattern.

10. The method for detecting the optimum viewing distance of three-dimensional display as claimed in claim 1, wherein the area of the testing pattern is less than the area of the display screen.
